(19) United States
(12) Patent Application Publication
(10) Pub. No.: US 2011/0280047 A1
(43) Pub. Date: Nov. 17, 2011

(54) Switching power adaptor circuit

(75) Inventor: Benson Chen, Kweishan Hsiang (TW)

(73) Assignee: Eng Electronic Co., Ltd.

(21) Appl. No.: 11/987,403

(22) Filed: Nov. 29, 2007

(51) Int. Cl. H02M 7/04

(52) U.S. Cl. 363/21.02

(57) ABSTRACT

An improved structure for a switching power adaptor circuit, primarily providing a switching power adaptor circuit for a RCC (Ringing Choke Converter) system, in which a control circuit is mainly structured from a bipolar junction transistor, a stable voltage sensing circuit, an over current protection circuit and an over voltage protection circuit, thereby providing the present invention with multiple protection effectiveness, which is able to ensure that the voltage at secondary winding output terminals is maintained at a stable value, thus improving safety in the use of electrical appliance products, and achieving effectiveness to reduce size and lower manufacturing costs.

### BACKGROUND OF THE INVENTION

(a) Field of the Invention

The present invention relates to an improved structure for a switching power adaptor circuit, and more particularly to a switching power adaptor suitable for use in power supply adapters of small household electrical appliance products, and primarily provides a switching power adaptor for a RCC (Ringing Choke Converter) system.

(b) Description of the Prior Art

In general, small household electrical appliance products, such as electronic stereo systems, video recorders and players, facsimile machines, cellular phone battery chargers, and the like, all use a direct current power supply having moderate power but optimum stability to convert the common electric supply into low voltage direct current to supply power for use by the appliance. A switching power adaptor circuit of the prior art, as depicted in FIG. 2, is primarily structured to enable current from an AC (alternating current) power source 21 to pass through a bridge type rectifier 22 and a filter 23, thereby producing a high voltage direct current, which then passes through a transformer 24 and an output rectifier circuit 25 to output a low voltage DC (direct current) power supply required by electronic products for use thereof.

Referring to FIG. 2, which depicts the switching power adaptor electric circuit of the prior art using a RCC (Ringing Choke Converter) system, and which is further structured to comprise a switch transistor (FET, field effect transistor) 26, a starting resistor 27, a positive feedback circuit 28, a control circuit 29 and a voltage sensing circuit 30. The control circuit 29 comprises a RC (resistor-capacitor) delay circuit structured from a resistor 291 and a capacitor 292. After the capacitor 292 has been charged to a certain degree, then the bipolar junction transistor 293 is turned on, thereby enabling a gate voltage of the switch transistor 26 to drop, and achieving effectiveness to delay turning off of the switch transistor 26. Moreover, prior to the switch transistor 26 turning off, current passes secondary winding 243 and converted into low voltage direct current. Accordingly, in one aspect, output terminals of the aforementioned secondary winding 243 implement charging of the capacitor 251 in the output rectifier circuit 25, and in another aspect, simultaneously provide electric power required by electronic equipment connected thereto.

Furthermore, after the switch transistor 26 turns off, because of electromagnetic induction, a feedback winding 242 of the transformer 24 produces like polarity current from a fourth terminal to a third terminal, and the voltage at the third terminal is reversed from a negative value into a positive value, after which the released current passing through a capacitor 281 in the positive feedback circuit 28 charges the gate of the switch transistor 26 until the gate voltage of the switch transistor 26 again increases to its original voltage Vt, whereupon the switch transistor 26 again reactivates the primary winding 241 to enable the continual passing of current. Accordingly, repeatedly carrying put identical operations and self oscillating, thereby enabling the primary winding 241 to continually transfer current capacity to the secondary winding 243, and achieving the objective of supplying power for use thereof.

However, according to the aforementioned switching power adaptor circuit of the prior art, in order to enable the transformer 24 to maintain a voltage difference between output terminals (Vo and GND) of the secondary winding 243 at a stable value, the voltage sensing circuit 30 is connected between the output terminals of the secondary winding 243. When the voltage sensing circuit 30 senses that the voltage difference between the two terminals is excessively high and has reached the breakdown voltage of a stable voltage diode 301 of the voltage sensing circuit 30, then power is conducted to a light-emitting diode 302 causing it to emit light, and an optically coupled transistor 294 in the control circuit 29 is made to turn on, thereby enabling positive voltage from the third terminal of the feedback winding 242 to implement charging and turning on of the gate of the bipolar junction transistor 293, which enables immediate suspension of current passing through the primary winding 241, and prevents the voltage difference between the two output terminals of the secondary winding 243 from increasing again, thus achieving effectiveness to maintain the output voltage value within a certain range.

However, when there is insufficient voltage to the AC power source 21 of the aforementioned prior art electric circuit, then the induced voltage produced by the third terminal of the feedback winding 242 drops, at which time, the control circuit 29 is unable to obtain adequate voltage to open the bipolar junction transistor 293, and is thus unable to close the switch transistor 26, causing the primary winding 241 to continue to conduct electricity, which results in the voltage at the output terminals of the secondary winding 243 continually rising, causing damage to electrical appliance products connected to the output terminals. Furthermore, because the voltage sensing electric circuit 30 uses the light-emitting diode 302 and the optically coupled transistor 294 in the control circuit 29 to serve as coupling controls, thus, size and manufacturing cost of the entire circuit structure is naturally increased. Hence, shortcomings in use and manufacture of the aforementioned switching power adaptor circuit of the prior art underlines the necessity for further research and improvement.

### SUMMARY OF THE INVENTION

In light of the shortcomings of the aforementioned switching power adaptor circuit of the prior art, there is still room for innovative research, accordingly, the inventor of the present invention, having accumulated years of experience in related arts, has meticulously carried out extensive study and exploration to ultimately design a new improved structure for a switching power adaptor circuit.

A primarily objective of the present invention is to provide an improved structure for a switching power adaptor circuit, in which a control circuit connected to a switch transistor is at the same time provided with a stable voltage sensing circuit, an overcurrent protection circuit and an overvoltage protection circuit, thereby providing multiple protection effectiveness, and is able to ensure that the voltage at secondary winding output terminals is maintained at a stable value, thus improving safety in the use of electrical appliance products.

Another objective of the present invention is to provide the improved structure for a switching power adaptor circuit, in which the control circuit connected to the switch transistor directly captures a feedback signal in a circuit at a primary side of a transformer, and size of the magnitude of voltage of the feedback signal operates control of the opening or closing of the switch transistor, thereby improving on control component members, including the light-emitting diode and optically coupled transistor, used in the prior art circuit, and achieving effectiveness to reduce size and lower manufacturing costs.

Yet another objective of the present invention is to provide the improved structure for a switching power adaptor circuit, in which, when voltage of the AC (alternating current) main power source is insufficient and a bipolar junction transistor is unable to close the switch transistor, then the over current protection circuit is able to be used to turn on the bipolar junction transistor and turn off the switch transistor.

Yet another objective of the present invention is to provide the improved structure for a switching power adaptor circuit, in which, when an excessively high voltage passes through a secondary winding of the transformer, then the over voltage protection circuit is able to be used to turn on the bipolar junction transistor and turns off the switch transistor.

In order to achieve the aforementioned objectives, the improved structure for a switching power adaptor circuit of the present invention primarily comprises an AC (alternating current) to DC (direct current) rectifier, a transformer, a switch transistor, a starting circuit, an output rectifier circuit and a control circuit, wherein the transformer comprises a primary winding, a feedback winding and a secondary winding. A first terminal of the primary winding is connected to a positive electric terminal of the rectifier, and a second terminal is connected to drain of the switch transistor. A third terminal of the feedback winding is connected to a gate of the switch transistor through a positive feedback circuit, and a fourth terminal is connected to a negative electric terminal of the rectifier through a capacitor, and is used to turn on the switch transistor after being turned off. A fifth and sixth terminal of the secondary winding are respectively positive and negative electric output terminals for induced current, and are connected to the output rectifier circuit to supply electric power for use by electric appliances. The switch transistor is used to control whether or not the primary winding conducts electricity to a switch. The starting circuit is connected between the first terminal of the primary winding and the gate of the switch transistor, and is used to provide the required voltage to the switch transistor at the initial turn-on. The switching power adaptor circuit is characterized in that:

The control circuit is used to control turn-off time of the switch transistor, and comprises a bipolar junction transistor, the stable voltage sensing circuit, the over current protection circuit and the over voltage protection circuit. A base electrode of the bipolar junction transistor is connected to a source electrode of the switch transistor. A collector is connected to the gate of the switch transistor, and an emitter is connected to the negative electric terminal (earth connection). The stable voltage sensing circuit comprises a series-connected stable voltage diode and electric resistor, a positive electrical terminal of the stable voltage diode is connected to the base electrode of the bipolar junction transistor, and another terminal of the resistor is connected to the fourth terminal of the feedback winding. The overcurrent protection circuit comprises two parallel resistors connected in series to the source electrode of the switch transistor, wherein another terminal of one of the resistors is connected to the base electrode of the bipolar junction transistor, while another terminal of the other resistor is connected to the negative electric terminal. The over voltage protection circuit comprises a positive electrical terminal connected to the base electrode of the bipolar junction transistor, while another terminal is connected to a stable voltage diode of the fourth terminal of the feedback winding.

According to the aforementioned structure, when in use, the stable voltage sensing circuit uses its connection to the negative electric terminal mutually connected to the fourth terminal of the feedback winding to enable the voltage released by the fourth terminal of the feedback winding to be fed back to the stable voltage diode until the stable voltage diode reaches a breakdown voltage, whereupon charging and starting up of the base electrode of the bipolar junction transistor can be carried out, and the switch transistor is caused to close down, thereby suspending conduction of electric current through the primary winding and achieving effectiveness to enable output voltage of the secondary winding to be maintained at a definite standard value. In addition, when an excessively large electric current passes through the switch transistor, then the overcurrent protection circuit causes a portion of the current to pass through the parallel resistor to implement charging and turning on of the base electrode of the bipolar junction transistor, and causing the switch transistor to turn off, thereby suspending conduction of electric current through the primary winding and achieving over current protection effectiveness. Furthermore, when an excessively large voltage passes through the switch transistor, then the overvoltage protection circuit causes an induction voltage of the feedback winding to correspondingly increase, and when the rising voltage reaches the breakdown voltage of the stable voltage diode of the over voltage protection circuit, then the feedback voltage of the fourth terminal of the feedback winding implements charging and turning on of the base electrode of the bipolar junction transistor, thereby achieving overvoltage protection effectiveness.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a circuit diagram of the present invention.

FIG. 2 shows a circuit diagram of a switching power adaptor of the prior art.

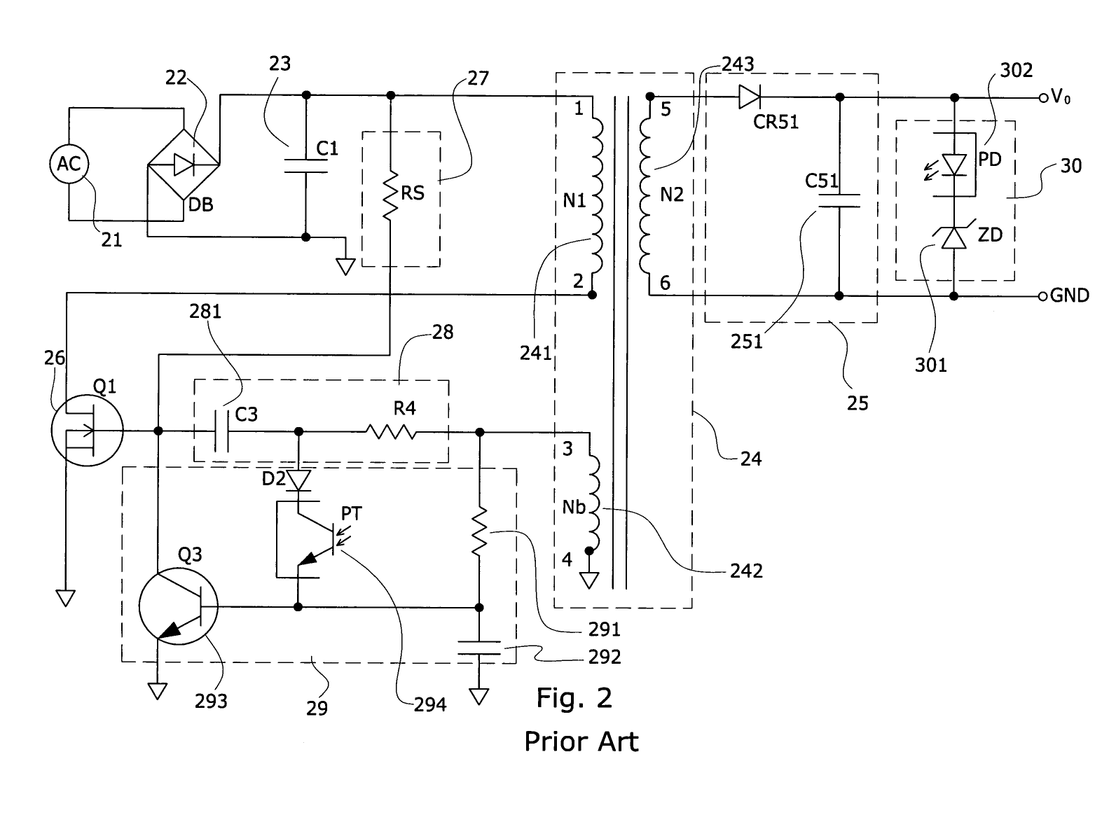

### DETAILED DESCRIPTION OF THE PREFERRED EMBODIMENTS

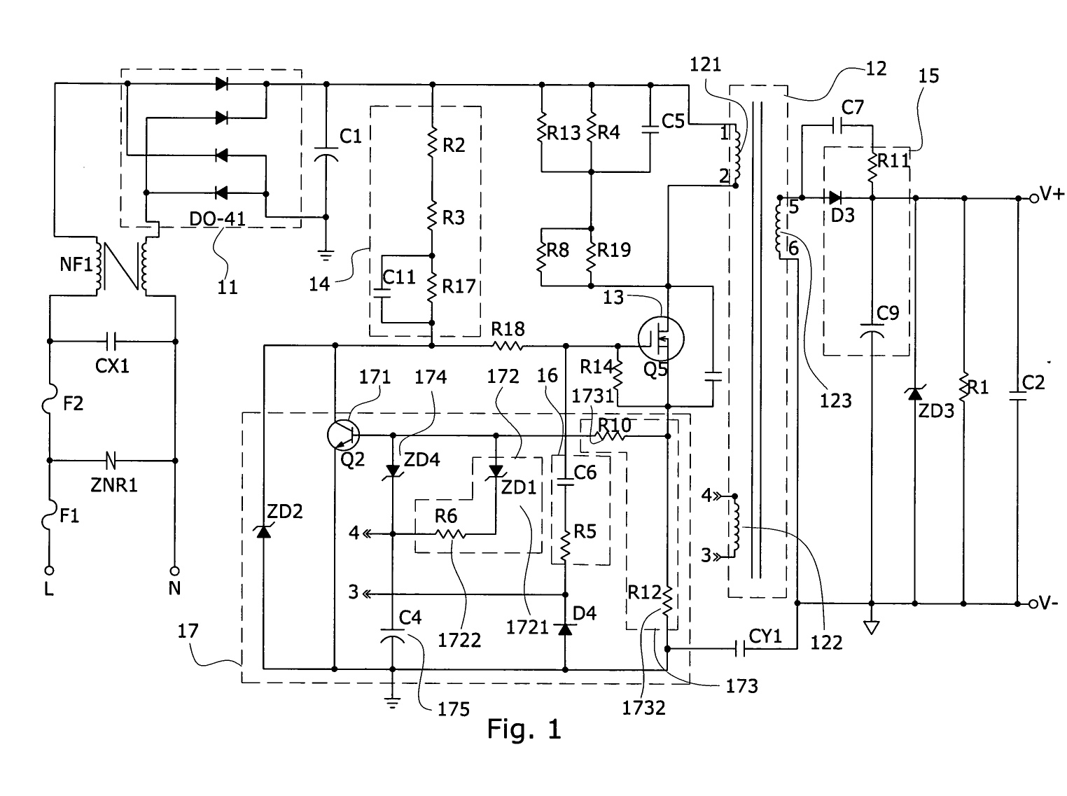

Referring to FIG. 1, which shows an improved structure for a switching power adaptor circuit of the present invention primarily structured to comprise an AC (alternating current) to DC (direct current) rectifier 11, a transformer 12, a switch transistor 13, a starting circuit 14, an output rectifier circuit 15, a positive feedback circuit 16 and a control circuit 17, wherein the transformer 12 comprises a primary winding 121, a feedback winding 122 and a secondary winding 123. A first terminal of the primary winding 121 is connected to a positive electric terminal of the rectifier 11, and a second terminal is connected to drain of the switch transistor 13. A third terminal of the feedback winding 122 is connected to a gate of the switch transistor 13 through the positive feedback circuit 16, and a fourth terminal is connected to a negative electric terminal of the rectifier 11 through a capacitor 175, and is used to actuate turning on of the switch transistor 13 after being turned off. A fifth and sixth terminal of the secondary winding 123 are respectively positive and negative electric output terminals for induced current, and are connected to an output rectifier circuit 15 to supply electric power for use by electric appliances connected thereto. The switch transistor 13 is used to control whether or not the primary winding 121 conducts electricity to an electronic switch. The starting circuit 14 is connected between the first terminal of the primary winding 121 and the gate of the switch transistor 13, and is used to provide the required voltage to the switch transistor 13 for supplying power at the initial turn-on. The present invention is characterized in that:

The control circuit 17 is used to control turn-off time of the switch transistor 13, and comprises a bipolar junction transistor 171, a stable voltage sensing circuit 172, an over current protection circuit 173 and an over voltage protection circuit 174. A base electrode of the bipolar junction transistor 171 is connected to a source electrode of the switch transistor 13. A collector is connected to the gate of the switch transistor 13, and an emitter is connected to the negative electric terminal. The stable voltage sensing circuit 172 comprises a series-connected stable voltage diode 1721 and electric resistor 1722. A positive electrical terminal of the stable voltage diode 1721 is connected to the base electrode of the bipolar junction transistor 171, and another terminal of the resistor 1722 is connected to the fourth terminal of the feedback winding 122. The over current protection circuit 173 comprises two parallel resistors 1731, 1732 connected in series to the source electrode of the switch transistor 13, wherein another terminal of the resistor 1731 is connected to the base electrode of the bipolar junction transistor 171, while another terminal of the other resistor 1732 is connected to the negative electric terminal. The over voltage protection circuit 174 comprises a positive electrical terminal connected to the base electrode of the bipolar junction transistor 171, while another terminal is connected to a stable voltage diode of the fourth terminal of the feedback winding 122.

According to the aforementioned structure, when in use, the stable voltage sensing circuit 172 uses its connection to the negative electric terminal through a capacitor mutually connected to the fourth terminal of the feedback winding 122 to enable the voltage released by the fourth terminal of the feedback winding 122 to be fed back to the stable voltage diode 1721 of the stable voltage sensing circuit 172 until the stable voltage diode 1721 reaches a breakdown voltage, whereupon charging and starting up of the base electrode of the bipolar junction transistor 171 can be carried out, and causes the magnitude of voltage at the gate terminal of the switch transistor 13 to fall and the switch transistor 13 to turn off, thereby suspending conduction of electric current through the primary winding 121 and achieving effectiveness to enable output voltage of the secondary winding 123 to be maintained at a definite standard value. In addition, when an excessively large electric current passes through the switch transistor 13, then the over current protection circuit 173 causes a portion of the current to pass through the parallel resistor 1731 to implement charging and turning on of the base electrode of the bipolar junction transistor 171, and also causes the switch transistor 13 to turn off, thereby suspending conduction of electric current through the primary winding 121 and achieving over current protection effectiveness. Furthermore, when an excessively large voltage passes through the secondary winding of transformer, then the over voltage protection circuit 174 causes an induction voltage of the feedback winding 122 to correspondingly increase, and when the rising voltage reaches the breakdown voltage of the stable voltage diode of the overvoltage protection circuit 174, then the feedback voltage of the fourth terminal of the feedback winding 122 is able to implement charging and turning on of the base electrode of the bipolar junction transistor 171, thereby achieving over voltage protection effectiveness.

According to the aforementioned, the stable voltage sensing circuit 172 used by the present invention is configured between the base electrode of the bipolar junction transistor 171 and the fourth terminal of the feedback winding 122, and is thus directly disposed at a primary side of the transformer 12. Moreover, the present invention does not use control component members, including light-emitting diodes PD (photodiode) and optically coupled transistors PT (phototransistor), frequently used in control circuits of the prior art, and thus is able to achieve effectiveness to reduce size of the power adaptor and lower manufacturing costs.

In conclusion, the improved structure for a switching power adaptor circuit of the present invention is clearly able to achieve effectiveness to provide multiple protection, reduce size and lower manufacturing costs, as well as increasing practicability and economic value of the product. Moreover, prior to this application, similar articles or technology to that of the present invention have not been seen in publications or in public use, thus complying with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A switching power adaptor circuit, comprising an AC (alternating current) to DC (direct current) rectifier, a transformer, a switch transistor, a starting circuit, an output rectifier circuit, a positive feedback circuit and a control circuit, wherein the transformer comprises a primary winding, a feedback winding and a secondary winding; a first terminal of the primary winding is connected to a positive electric terminal of the rectifier, and a second terminal is connected to drain of the switch transistor; a third terminal of the feedback winding is connected to a gate of the switch transistor through the positive feedback circuit, and a fourth terminal is connected to a negative electric terminal of the rectifier through a capacitor, and is used to turn on the switch transistor after being turned off; a fifth and sixth terminal of the secondary winding are respectively positive and negative electric output terminals for induced current, and are connected to an output rectifier circuit to supply electric power for use by electric appliances; the switch transistor is used to control whether or not the primary winding conducts electricity to a switch; the starting circuit is connected between the first terminal of the primary winding and the gate of the switch transistor, and is used to provide the required voltage to the switch transistor at the initial turn-on; the switching power adaptor circuit is characterized in that:
the control circuit is used to control turn-off time of the switch transistor, and comprises a bipolar junction transistor, a stable voltage sensing circuit, an over current protection circuit and an over voltage protection circuit; a base electrode of the bipolar junction transistor is connected to a source electrode of the switch transistor, a collector is connected to the gate of the switch transistor, and an emitter is connected to the negative electric terminal; the stable voltage sensing circuit comprises a series-connected stable voltage diode and electric resistor, a positive electrical terminal of the stable voltage diode is connected to the base electrode of the bipolar junction transistor, and another terminal of the resistor is connected to the fourth terminal of the feedback winding; the over current protection circuit comprises two parallel resistors connected in series to the source electrode of the switch transistor, wherein another terminal of one of the resistors is connected to the base electrode of the bipolar junction transistor, while another terminal of the other resistor is connected to the negative electric terminal; the over voltage protection circuit comprises a positive electrical terminal connected to the base electrode of the bipolar junction transistor, while another terminal is connected to a stable voltage diode of the fourth terminal of the feedback winding.
